(19) United States
(12) Patent Application Publication
(10) Pub. No.: US 2026/0244858 A1
(43) Pub. Date: Aug. 20, 2026

(54) SYSTEM AND METHOD FOR LANGUAGE AND MEDIA DATA TRACKING

(71) Applicant: MarTech Connect LLC dba Side Nerd Apps, Charlottsville, VA (US)

(72) Inventor: EMILY SMITH, CHARLOTTSVILLE, VA (US)

(21) Appl. No.: 19/543,999

(22) Filed: Feb. 19, 2026

Related U.S. Application Data
(60) Provisional application No. 63/760,279, filed on Feb. 19, 2025.

(51) Int. Cl. G06F 40/279; G06F 40/40

(52) U.S. Cl. CPC G06F 40/279; G06F 40/40

(57) ABSTRACT

Provided is an improved system and method for language and media data tracking and analysis. The system includes a no-code platform for constructing and managing natural language applications across multiple messaging channels. The system converts unstructured inbound messages into structured, actionable datasets without requiring custom coding. Administrators can define data extraction schemas, contextual references, and response templates through a simple, form-based interface. The features include data logging, context-specific inquiries, feedback, reports, and emergency notifications. AI models, including language and embedding-based vector search models, can interpret inbound messages, extract relevant fields, and retrieve contextual data. Parameterized visualization modules provide administrators and end users immediate access to dashboards and reports of the retrieved data.

### RELATED APPLICATIONS

This application claims the benefit of U.S. Provisional Application No. 63/760,279, filed on Feb. 19, 2025, the entirety of which is incorporated herein by reference.

### TECHNICAL FIELD

The present disclosure relates to systems and methods for language processing and, in particular, to the tracking, storage, analysis, and display of language and media data.

### BACKGROUND

Interaction via text-based messaging is becoming increasingly sought after in various domains, including social, professional, educational, recreational, and service-oriented interactions. For instance, business organizations now recognize that customers, clients, or employees may prefer to interact via text-based messaging for administrative or business-related tasks. Software platform companies recognize that offering a text-based messaging channel interface for customers and clients to use to interact with their digital product, in addition to or as a replacement for a native or web application interface, may reduce costs and improve user experience.

Text-based interactions can contain valuable data, such as user feedback, operational metrics, measurements, or transaction details. Conventional language processing applications often fail to effectively process and utilize data received from these text-based interactions. Additionally, conventional tools may require time-consuming configuration or custom integration with other services to achieve desired results.

For instance, conventional rule-based applications (e.g., sometimes referred to as chatbots) primarily focus on and require scripted conversations, while providing no mechanisms for data extraction and visualization. More advanced artificial intelligence (AI) driven systems, on the other hand, often fail to adequately address data logging and analytics of the text data aggregated across users. These conventional systems may require custom integrations or additional design to export transcripts and build dashboards with visual representations. Even no-code platforms with AI integrations do not offer configurable, schema-driven data extraction or direct parameterized visualization for both administrators and end users.

Therefore, it is desirable to provide an improved system or method related to text-based language processing that is easy to use and easy to configure. It may also be desirable to provide an improved system to leverage data extracted from text-based messaging without requiring difficult application integration.

### SUMMARY OF INVENTION

The present application provides a no-code, data-centric system and method for constructing and managing natural language applications that operate across various messaging channels. Unlike existing chatbot or conversational AI tools, the disclosed system converts unstructured inbound text, audio, or visual messages into structured, actionable datasets without requiring custom development or external integrations.

In an example implementation, a system for text-based language data tracking includes an administrative interface for configuring at least one language tracking parameter, where the at least one language tracking parameter identifies data that is to be extracted from text-based language data received from a user. The system further includes a data routing interface configured to receive language tracking data from a communication interface and to route the language tracking data to one or more modules of the system. One or more data storage modules comprising at least one database are configured to store at least a portion of the received language tracking data. In some implementations, the data storage module includes at least one database or cloud storage system. In addition to the above, a data processing module is configured to analyze and extract relevant data from a portion of the received language tracking data such that the data is analyzed and extracted according to the configured language tracking parameters.

Similarly, a method for tracking text-based language data includes configuring, via an administrative interface, at least one language tracking parameter, such that the at least one language tracking parameter identifies data that is to be extracted from text-based language data received from a user that is related to a language tracking scenario. The method further includes receiving, from a user device, language data associated with the language tracking scenario, and storing at least a portion of the received language data in at least one database. Using at least one data processing application, a portion of the language data received from the user device is analyzed to extract relevant language data according to the configured at least one language tracking parameter.

The foregoing and other features will be described in greater detail with reference to the accompanying drawings.

### BRIEF DESCRIPTION OF THE DRAWINGS

FIG. 1 is an exemplary system architecture diagram of a language data tracking system as disclosed herein.

FIG. 2 is an exemplary component diagram of the language data tracking system as disclosed herein.

FIGS. 3A-3B illustrate another exemplary system architecture diagram of a language data tracking system as disclosed herein.

FIG. 4 is an exemplary implementation of a text-based interaction between a user and a language data tracking system.

FIG. 5 is another exemplary implementation of a text-based interaction between a user and a language data tracking system.

FIG. 6 is another exemplary implementation of a text-based interaction between a user and a language data tracking system.

FIG. 7 is another exemplary implementation of a text-based interaction between a user and a language data tracking system.

FIG. 8 is an exemplary implementation of a visual representation of data extracted from the language data tracking system.

FIGS. 9A-9B illustrate an exemplary implementation of an administrative interface featuring an application manager dashboard of the language data tracking system.

FIGS. 10A-10B illustrate an exemplary implementation of an administrative interface featuring data extraction configuration.

FIGS. 11A-11B illustrate an exemplary implementation of an administrative interface featuring an application manager dashboard for messaging integration.

FIG. 12 is an exemplary implementation of an administrative interface featuring an application manager dashboard for database integration.

FIG. 13 is an exemplary implementation of an administrative interface featuring an application manager dashboard for data uploads.

FIGS. 14A-14B illustrate an exemplary implementation of an administrative interface featuring an application manager dashboard for managing users and user permissions.

FIGS. 15A-15C illustrate an exemplary implementation of an administrative interface dashboard.

FIG. 16 is an exemplary application manager dashboard for historical logging and configuration.

FIG. 17 is an exemplary implementation of an administrative interface featuring an application manager dashboard for data visualization and reporting.

### DETAILED DESCRIPTION

Provided herein is a system and method for constructing and managing natural language applications that may operate across various messaging channels. The system includes improvements compared to conventional language tracking systems which represent significant advantages to users and businesses.

For instance, unlike existing chatbot or conversational AI tools, the system disclosed herein converts unstructured inbound messages into structured, actionable datasets without requiring custom development or external integrations. Through a low code or form-based administrative interface, non-technical users and clients can define data extraction schemas, contextual reference materials, and response templates tailored to a defined set of message categories. These categories may include context-specific inquiries, data logging requests, report or summary requests, informational queries about the application's functionality, feedback submissions, and emergency notifications. By establishing clearly defined handling logic for each category, the system may effectively simplify the application-building process while supporting a wide range of real-world use cases. Those skilled in the art will readily appreciate the cost and time savings associated with the system disclosed herein.

Moreover, the system can leverage artificial intelligence (AI) models, including language models and embedding-based vector searches, to interpret user messages, extract relevant fields, handle incomplete or ambiguous information, and reference contextual data from integrated databases. The system may employ both NoSQL and SQL databases, as well as cloud document storage, enabling flexible schema evolution, robust logging, and efficient querying. Additionally, parameterized visualization links can be generated directly from the system, granting both administrators and end users immediate access to dashboards or reporting tools for data-driven insights.

The system disclosed herein may transform the development of conversational applications into a fully configurable, no-code environment. By unifying messaging, AI-driven extraction, data management, and integrated visualization, the system may enable organizations to rapidly derive meaningful insights from their natural language interactions across diverse communication channels. This may be done without the need for complex coding or integration, which may save organizations or users time and money. Moreover, the system may also offer technical improvements compared to conventional systems through improved performance, data logged, and data visualizations.

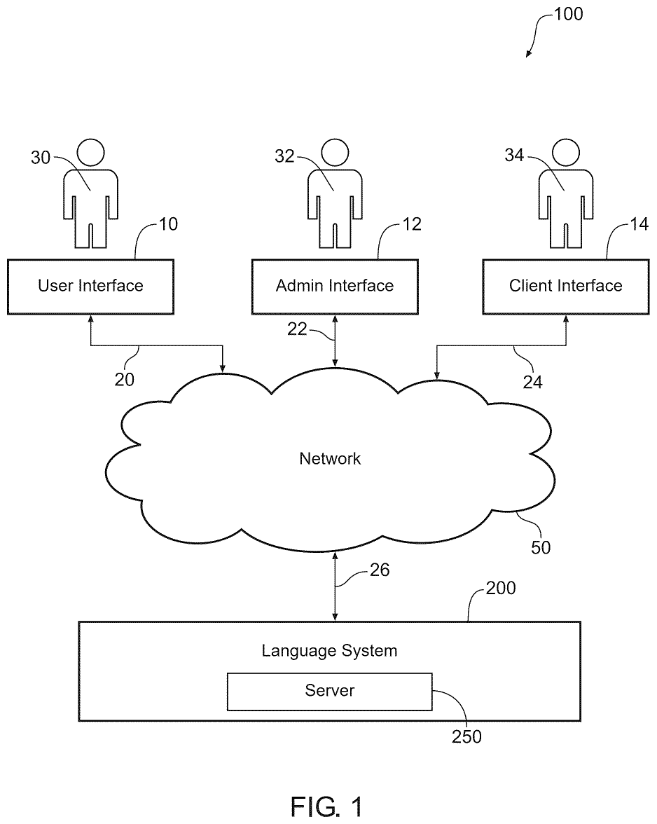

Turning now to FIG. 1, a system architecture for an overall data system 100 is shown. The system 100 can include a user interface 10, an administrative interface 12, and a client system interface 14. The user interface 10, the administrative interface 12, and the client system interface 14 may communicate with at least one network 50 via at least one communication path 20, 22, and 24 respectively. The system 100 can further include a language data system 200, which may interact with at least one of the user interface 10, the administrative interface 12, or the client system interface 14 to process at least a portion of language data. Users 30, 32, and 34 may interact with at least one of the user interface 10, the administrative interface 12, or the client system interface 14 to facilitate sending or receiving text-based communication, messages, implementing configuration or parameters, or other relevant data to the system 200. The language data tracking system 200 may also be referred to as a data tracking system 200, a data system 200, a tracking system 200, a data system 200, or simply the system 200.

It should be appreciated that the language system 200 can be any combination of local, remote, or cloud-based as part of a cloud computing environment. In various embodiments, the language system 200 can comprise various hardware and software components such as at least one controller, processor, or server 250. The server 250 can also be distributed among multiple locations and/or devices. Additionally, the server 250 can be at least one of a website, a server device, a computer, a cloud-service, application, interface, a processor and memory, a computing device connected to the Internet and connected to a user device, or any combination of the same. In some embodiments, the system 200 or a portion of its components may be serverless or function as a cloud-based deployment model, enabling horizontal scalability and fault tolerance as message volume or data complexity increases, without requiring code modifications or manual infrastructure adjustments.

In some embodiments, the user interface 10, the administrative interface 12, and the client system interface 14 may include respective user devices, administrative devices, and client devices. The devices may be any of a wireless communication device, a cell phone, a computer, a tablet, a smart watch, or any other suitable electronic device. Yet in other embodiments, the various interfaces may represent server-to-server based communication rather than human managed interfaces. For instance, the client system interface 14 may represent a server-to-server interface for interfacing directly with at least one client system. In this example, the client system interface 14 may facilitate connection directly to a client's backend infrastructure, enabling automated retrieval of configuration parameters and rule-based routing logic adjustments. The client system interface 14 may operate in a server-to-server manner, minimizing human intervention and enhancing efficiency in deployment. It should be appreciated that the client system interface 14 may operate in any suitable manner according to system configuration and access requirements.

In general, the network 50 can be implemented to couple one or more devices of system 100 via wired or wireless connectivity, over which data communications are enabled between devices and between the network and at least one of a second network, a subnetwork of the network, or a combination thereof. Any suitable number of networks can be used with the subject innovation and data communication on networks can be selected by one of sound engineering judgment and/or one skilled in the art. For instance, the network 50 may include any combination of technologies such as Wi-Fi, Bluetooth, cellular networks, ethernet, LAN, etc.

By way of example, a use case for the system 200 may include at least an initial configuration by an administrator using the admin interface 12, an interaction with at least one end user using the user interface 10, analysis of message data, and visualization of the message data. Application interfaces may feature no-code, form-based interfaces to allow users without computer programming expertise to setup, configure, modify, or oversee the system 200. As discussed herein, a no-code application interface may refer to any suitable interface that features a user-friendly platform that enables individuals to create, edit, or configure software applications without writing any code. These interfaces may utilize visual tools like drag-and-drop components, pre-built templates, and intuitive workflows, allowing users to design and deploy applications efficiently.

Configuration by an administrator 32 may include the use of a form-based admin interface 12 to define application behaviors, data extraction schemas, and contextual data references without writing code (e.g. no-code configuration). This includes specifying required and optional fields, validation rules, and response templates, as well as routing criteria based on inbound message metadata. To do this, an administrator may log in with admin credentials, select or create an application, define routing rules and data extraction fields, upload contextual datasets, and/or configure response templates. The administrator may test these settings with sample messages before activation.

In an embodiment, categories of inbound messages defined via the no-code admin interface 12 include at least one of context-specific inquiries, data logging requests, requests for reports or summaries, queries about the application's functionality, user feedback submissions, and emergency notifications. Moreover, the no-code interface allows an administrator to specify required and/or optional data fields for each data extraction schema, including data types and validation rules. The admin interface 12 can also enable an administrator to edit or add records to various databases manually, and to upload or remove contextual reference files, thereby providing direct administrative control over both configuration and stored data without requiring specialized technical skills.

Interaction with an end user 30 may include at least sending and receiving text or media-based messages through a platform on a user device. In certain cases, the user device is a cell phone, and the text-based messages are SMS messages. The system 200 can determine the correct application logic to analyze and extract structured data from the received text messages. This may be done using AI and references to contextual embeddings if needed. The data may be processed and stored in both SQL and NoSQL databases, or any combination thereof, including other cloud-based document or media storage configurations. The system 200 can formulate and return a response to the user if required.

A user (e.g., user 30, 32, 34) can also request a data report which may be in the form of a visualization. For example, when a user requests summarized data or a report, the system 200 can generate a parameterized link to a dashboard, drawing directly from a SQL repository or cloud storage document. This allows immediate access to aggregated metrics, historical logs, and contextual insights. Admins can view data visualizations and summaries in their admin interface or chosen external platform. Visualization may be in the form of numerical data, images, text based data, graphs, or any other relevant visualization technique.

That is, in a preferred embodiment, a language tracking system 200 may be provided to receive and analyze language data from a user 30 communicated to the system 200 via user interface 10. The user interface 10 may be a component or application of a user device such as a cell phone, and the language data may include SMS text messages. The SMS text messages can be analyzed by the system 200 according to one or more language tracking parameters configured by an administrator 32 via the administrator interface 12. The user 30 may interact with the system 200 to provide data, feedback, or other text-based communication or inquiries. Moreover, the system 200 can provide visual representations of collected data to the user 30. Additional details will be described below.

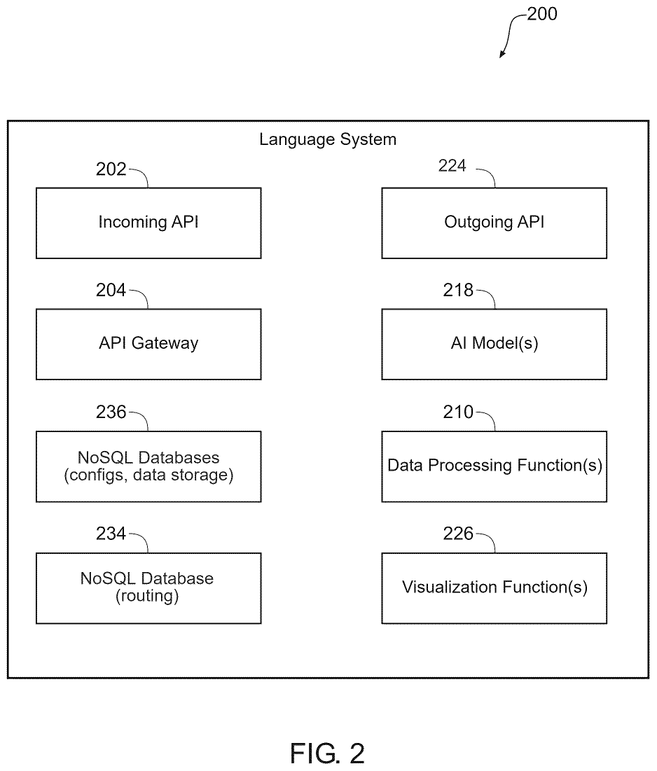

FIG. 2 illustrates an exemplary component diagram of the language data system 200. The language system 200 may comprise an incoming API 202, an outgoing API 224, an API gateway 204, at least one database in the form of a NoSQL configuration database 236 and/or a NoSQL routing database 234, at least one AI model 218, at least one data processing function 210, and at least one visualization function 226. It should be appreciated that the components of the system 200 may be applications, functions, modules, or interfaces that may operate on any combination of hardware and/or software.

The incoming application program interface (API) 202 may interact with third party communication services to retrieve messaging data (e.g., SMS, email, text, or other chat functions) from the third-party services (e.g., Twilio, WhatsApp, Facebook Gmail, Telegram, etc.). For instance, when an incoming text message occurs, a request from the third-party communication application may be sent to the system 200 via a webhook. Similarly, the outgoing API 224 may interact with third party communication services to send messaging data from the system 200 to the third-party services (e.g., Twilio). Additionally, an API gateway 204 may be utilized to manage API routing and requests through the system 200.

It should be appreciated that the system 200 may be configured to handle interactions via email, text, or other chat functions. The data sent via the various messaging systems or chat functions may include text based data or other media types. Other media types may include images, audio recordings, voicemail recordings, video, live audio, live video, or any suitable combination of media without deviating from the scope of the disclosure. The system 200 may further be configured to process various documents or file types in which various relevant data is present.

The system 200 can also include at least one database. In certain embodiments, the system 200 can include at least one database in the form of a combination of either NoSQL or SQL databases. In the example illustrated, a NoSQL configuration database 236 and a NoSQL routing database 234 may be used, although any suitable database or combination of databases may theoretically be used. The databases can receive and store information from any of the client, administrative, or user devices or interfaces. The databases may be a standalone storage component or may exist as part of a server, like server 250. In an embodiment, the NoSQL configuration and storage databases 236 may store flexible configuration data, raw messages, and context embeddings, while the NoSQL routing database(s) 234 may maintain data that maps incoming message metadata to the correct application behavior and parameters defined in 236 databases. In some implementations, a combination of both NoSQL and SQL database may support evolving data needs, efficient querying, and straightforward integration with visualization tools. In another embodiment, the system 200 may be configured to utilize primarily or entirely all NoSQL databases (e.g., 234 and 236) to improve data accessibility and user experience. In this instance, the NoSQL databases 236 may store flexible configuration data, raw messages, context embeddings, structured log entries, and any other data or messages.

In an example implementation, raw inbound content and metadata (e.g., SMS text, email/chat, and attachments) are recorded to a NoSQL portion the NoSQL database(s) 236. Administrative configuration, and contextual reference uploads can reside in NoSQL (e.g., App Configs NoSQL Database 336), while a separate SQL or NoSQL Routing Database 334 (e.g., DynamoDB) can support application selection based on inbound metadata, enabling channel-agnostic, multitenant handling. Intermediate items produced during processing can be stored with the message records in NoSQL database 236 to facilitate retrieval and updates. After extraction and post-processing, normalized structured log entries are written to the App-Specific SQL or general structured NoSQL Database 338, which serves as the authoritative, query-optimized source for analytics and reporting. Parameterized visualization links generated by the system (e.g., via visualization function(s) 226/end-user visualization 326) access these centralized NoSQL databases through an API (e.g., such as CRUD API). The retrieved data can be processed into structured, field-type-managed data frames rendered in an administrative interface or a real-time visualization. In this manner, the dashboards and reports can pull directly from the centralized data sources without requiring a separate SQL layer. As discussed above, the system 200 may be configured to utilize the NoSQL database 236 or a combination of NoSQL databases rather than relying on SQL databases. This may improve various functions of the system, may reduce costs, and may ensure for efficient scalability of the system.

The system 200 may further include AI-based models 218 or extraction tools and various data processing functions 210. In this regard, the system 200 may integrate with various external text, vision, or audio language models and embedding-based vector search services to analyze and extract text data from various platforms. When a message arrives, an AI model 218 may review message content according to an administrative-defined schema, extract relevant fields, and resolve ambiguities by prompting users for clarification if necessary. Vector embeddings enable the retrieval of contextual data points, improving response accuracy and relevance. Various data processing functions 210 may analyze the extracted data according to previously defined parameters and configurations.

It should be appreciated that message routing via the system 200 may be “channel-agnostic”, referring to the ability to handle inbound messages from multiple communication platforms (e.g., SMS, email, WhatsApp, Slack, etc.) without requiring separate codebases or applications for each channel. Therefore, the system 200 may be able to integrate multiple messaging services without the need to configure distinct processing logic for each. Instead, messages from all sources may flow into the system 200 to be processed and handled uniformly, which may make the system 200 more efficient, scalable, and easier to maintain.

The system 200 may further include at least one visualization function 226 to visualize various data extracted from the message data. The system 200 can generate parameterized visualization links directly from the stored data, enabling end users to access dashboards or reports through the original messaging interface. These visualizations, tied to the NoSQL data storage layer (or SQL layer or document layer) 236, may provide immediate insights into the structured information extracted from inbound messages.

In certain implementations, the disclosed system design and architecture can improve the functioning of computer systems by reducing latency, enabling scaling without code changes, and providing fault-tolerant processing of high-volume traffic. In some instances, the system further achieves a technological improvement in data management by separating concerns between NoSQL databases 236 for flexible capture of raw messages (312), configuration (336), embeddings, and SQL or NoSQL database(s) 338 for normalized, query-optimized log entries, enabling efficient analytics without custom export tools. Accuracy and reliability of information extraction can be enhanced by embedding processing (AI Model APIs 318) that retrieves contextual references before field parsing under admin-defined schemas, improving accuracy and saving time. Finally, parameterized visualization links bound to the App-Specific SQL or general NoSQL Database 236/338 (End User Data Visualization 326) provide immediate, secure access to dashboards directly from the messaging flow, eliminating bespoke integrations and lowering computational overhead for repeated report generation.

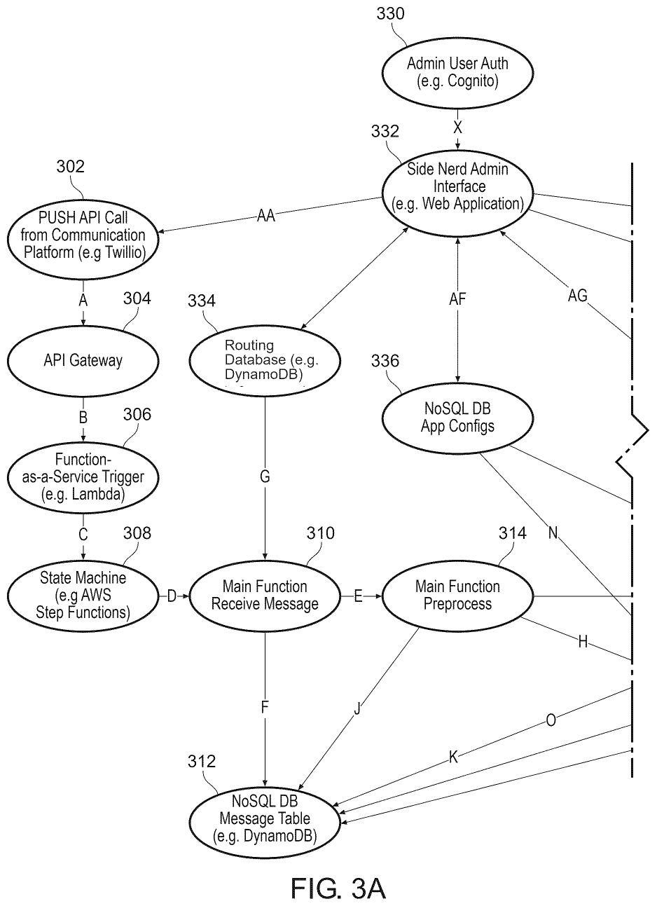

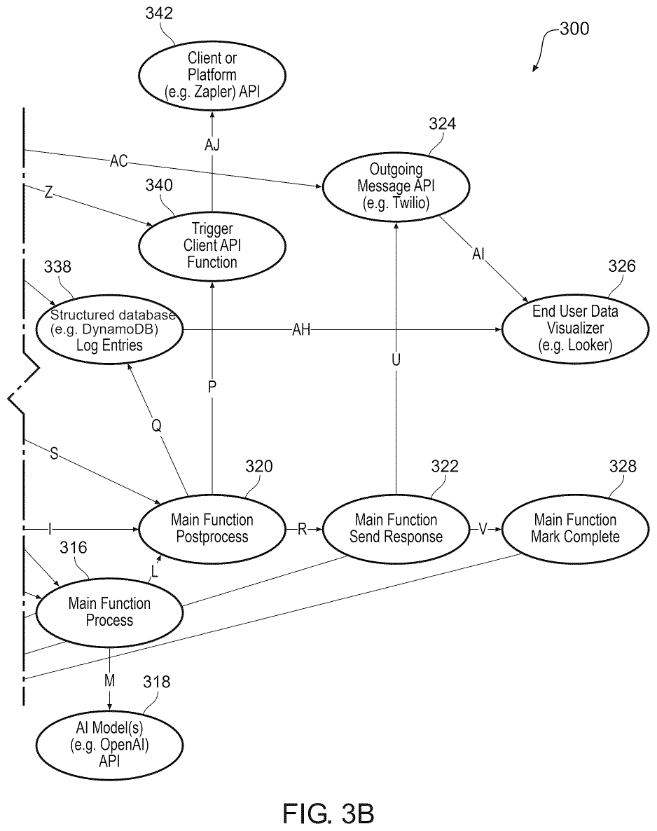

Turning to FIG. 3, a high-level system diagram is shown. The system diagram 300 is similar to and relates to the systems 100 and 200 in all ways except as noted herein. Therefore, disclosure for the system 300 is equally as applicable to the systems 100 and 200. Features similar to the system 200, are labeled with like reference numerals, incremented by 100. Moreover, the diagram 300 may illustrate how data and messages are received, routed, stored, analyzed, and visualized using and of the systems disclosed herein. Each component illustrated in FIG. 3 may represent steps or states associated with the messaging system or method. They may also represent an application, platform, interface, function, or instance of any suitable software or hardware. The components may reside on suitable servers, may be cloud-based, internet-based, or any suitable combination of the same without deviating from the scope of the application.

### Message Processing Data Flow

By way of example, at 302, a user 30 may send a message to a defined phone number, and a Twilio webhook may send an event to the system. The API Gateway 304 can receive the event (A) and can process the message data accordingly. A trigger function (C) may be triggered at 306 to initiate a state machine at 308. Here, the state machine may initiate (D) being a first step of main function, to receive a message. At component 310, the received messages accesses (G) the SQL or NoSQL Routing Database 334 and returns a code that matches the event metadata to the correct application project. It should be appreciated that SQL database routing may be replaced with NoSQL database routing, NoSQL database routing may be replaced with SQL database routing, or any combination thereof.

The system 300 may then save message data (F) as a NoSQL Messages Table (6) entry. All other Main Function steps update (J, K, O, W) the Messages Table entry. Receiving a message may further initiate (E) the Main Function Preprocess step. The preprocess step searches (J) the Messages Table for a previous related message and returns the content and previously extracted data, and if found, both messages are processed together. If content is flagged to be processed, the Main Function Process is initiated (H). The process references (N) the App Config database 336, which returns the values needed to process the message according to the admin's defined logic. The process then calls (M) one or more AI Model APIs to parse and query with the event using embedding and LMM-type models.

At 320, the process initiates (L) Main Function Postprocess with processed data. The postprocess saves each log entry (Q) to the App-specific SQL or general NoSQL database 338 (e.g., DynamoDB). Then, the postprocess formulates the application's response to the end user's message according to(S) the App Configuration 336. Moreover, the Main Function postprocess can also be initiated (I) by the preprocess if logic defines that the process step is to be skipped. The postprocess may initiate (P) the Trigger Client API Function 340. The postprocess initiates (R) the Send Response step.

At 324, the system 300 may send response calls (U) to the Outgoing Message API, sending an appropriate response back to the user 30. At 326, if the response is a report or data request, the URL directs (AI) the user to the relevant End User Data Visualization. The visualizer uses (AH) the Structured Log Database 338 (e.g., centralized NoSQL log database such as DynamoDB, SQL database, or hybrid storage layer) as its source data. If there are no open questions, the Message is marked complete by the Mark Complete function, affecting its future logic. In an embodiment, the App-Specific SQL DB Log Entries may be replaced by an app-specific csv file stored in the cloud and integrated to a visualization layer. It is contemplated that this may include a process for updating the respective files based on user requests, creating them from a general NoSQL logs database.

### Administrative Configuration Data Flow

FIG. 3 may further illustrate the steps that an administrator may take when authenticated into the system's no-code interface to define application behaviors, data extraction schemas, contextual reference datasets, and response templates. This figure highlights how the admin's configuration choices are propagated through databases and AI models to shape end user experiences.

For instance, at 330 the application may be purchased or contracted, and an admin user role may be created. The Admin User authenticates to access (X), which may be their management or admin interface 332 (or admin interface 12). An authenticated user may have row-level database permissions. The Admin user 32 may be granted access (X) to the Admin Interface 332. By setting up (AE) the Messaging Channel integration and the End User base list, entries are created in the Routing SQL or NoSQL Database 334 that will allow incoming messages from users to be routed and processed using defined parameters and configurations.

In the Admin Interface 332, the admin updates (AF) the application's configuration values stored in the App Configs NoSQL Database, which controls the behavior of the Process 316 and Postprocess 320 steps. In the Admin Interface 332, the admin updates (AG) their application's data extraction schema, which affects the schema of the App Specific SQL Database Log Entries Table. This schema affects the behavior of the Postprocess 320 step and serves as the source data (AH) for the End User Data Visualization 326. By setting up (Z), the Data Integration, the Trigger Client API Function's behavior is defined (Z). The Trigger Client API Function can send data (AJ) from Postprocess 320 to a third-party platform (allowing PUT and UPDATE methods).

In various implementations, an administrator accesses the Admin Interface 332 to configure one or more language tracking parameters that govern how the system inputs, interprets, and responds to messages. The language tracking parameters can include at least (i) a data extraction schema that specifies language data elements to be extracted from incoming language data, including field names, data types, required/optional status, and validation rules; and (ii) a user interaction schema that governs at least one interaction with the user device, including prompt text, follow-up question templates, disambiguation thresholds, response templates, and branching or escalation rules. The Admin Interface 332 can port these configurations to an App Configs NoSQL Database 336, from which the system may retrieve them at runtime without redeploying code. Various other modules of the system may reference the language tracking parameters when implementing configuration or processing data.

In certain implementations, the system 200 can use a hierarchical configuration in which various language tracking parameters and schemas can be defined at multiple levels. For example, such levels may include an organization level, a project level, and/or at a client level. In implementations were parameters and/or schemas are defined at multiple levels, they may be merged at runtime so that lower-level configurations override higher-level defaults (or vice versa) without requiring code changes. When incoming language data is received, the system 200 can load a master configuration, selecting the applicable project and environment, identifying the relevant client, and by merging parameters and schema in sequence to produce a configuration that dictates extraction, validation, and user interaction for that message. This approach allows administrators to establish organization defaults (e.g., standard field definitions, validation rules, and response templates) while permitting project specific overrides (e.g., custom prompts, adjusted thresholds, or additional tracked fields). These features are conveniently managed through the Administrative Interface 332.

The language tracking parameters may further include per-field configuration rules that are evaluated at runtime against data values and user context. For each tracked field, the configuration may specify visibility rules, validation rules, formatting constraints, editing restrictions, label mappings, and composite or merged fields. These per-field rules can enable the data processing module to adjust extraction logic, displays, and dashboard deliverables based on such configuration. Thus, the system 200 can produce different behaviors for different projects or clients without custom development or coding.

### Message and Data Flow Examples

In a typical message flow, a user can send a message to a phone number, and a webhook from the messaging provider can deliver that event to the system at the API Gateway 304, which accepts the request and hands it off for processing (e.g., Twilio to 304 at step A). The system 300 can invoke a Trigger Function 306 to start a State Machine 308 that coordinates the main processing steps for the message. The State Machine can begin with a Main Function: Receive Message 310, which can record the message and associated metadata so downstream steps can reference and update the entry. As part of this, the system 300 can reference the SQL or NoSQL Routing Database 334 to determine which application configuration applies. For example, based on the destination number or channel, the system may ensure the correct logic is used without need for custom code. The message content and metadata can be saved into a NoSQL Messages Table so that all subsequent steps can be read and so updates can be written against a single record for traceability (e.g., items J, K, O, W in FIG. 3).

Next, the Main Function: Preprocess 314 can check the Messages Table for any related prior messages. The Main Function: Process 316 can load the application configuration from the NoSQL database 336 to retrieve the admin-defined schema, routing rules, prompts, and validation settings that control various items for processing. During processing, one or more AI Model APIs 318 are called to analyze the inbound content. If the application logic indicates that processing can be skipped (for example, for simple replies), the system advances directly from Preprocess 314 to Postprocess 320 to format a response and complete logging.

The user interaction (defined by the Admin in the Admin Interface 332) schema may appropriate user prompts and templates, as well as the conditions under which they are presented. For example, the schema can define a first prompt to request a date in a specified format, a fallback prompt if the provided text does not match the date pattern, and an escalation rule to route to a predefined alert workflow. The same schema may also specify channel-specific formatting and limits (e.g., SMS character limits or markdown for chat), so that the Outgoing Message API 324 formats and transmits messages in a manner appropriate to the user's channel while preserving consistent data collection logic across channels.

In the Main Function: Postprocess 320, the system can write log entries to the App-Specific SQL or general NoSQL Database 338. Postprocess 320 can also format the outgoing response according to the App Configs 336, which can include confirmations, follow-up questions, or links. If the application integrates with external systems, Postprocess 320 can trigger the Client API Function 340 to push newly extracted data to third-party platforms as needed. The system can then trigger the Send Response 322 function and use the Outgoing Message API 324 to return the message to the user. The Mark Complete 328 process can update the Messages Table to indicate the conversation state for future logic.

Upon receipt of incoming language data via the communication path (e.g., API Gateway 304 and associated channel adapters), data routing logic consults a Routing Database 334 to select an application configuration and then supplies the applicable parameters to a data processing module that includes a schema-guided extraction (Process 316). During processing, the extraction engine can apply the data extraction schema (defined by the administrator) to the inbound language data by mapping field definitions to parsed values, enforcing type constraints and validation rules, and generating structured entries when required fields are satisfied. If a required field is missing or ambiguous under a configured confidence threshold, the user interaction schema can dictate a follow-up question to the user, after which processing continues when the user replies.

When the user requests data or a report, the response can include a link that directs them to End User Data Visualization 326, which reads from the App-Specific SQL Database or general NoSQL database 338. This can help deliver charts, tables, or summaries tied to their request. This can let users and administrators view results immediately without building a separate integration, because the visualization points directly at the structured log entries created during Postprocess 320. In some implementations, the SQL log entries may be replaced by or supplemented with cloud-hosted content.

On the administrative side, an admin can authenticate to the Admin Interface 332 and set up channel integrations and an initial user base list. This can create entries in the Routing Database 334 so inbound messages are routed to the right application automatically. Admins can also update App Configs in the NoSQL App Configs Database 336. Moreover, Admins can also configure Data Integrations that inform the Trigger Client API Function 340, for enabling outbound data to external systems.

Configuration of the language tracking parameters (by an Admin via Admin Interface 332) also can determine storage and analytics behavior without custom development. Raw message bodies and intermediate data such as transcripts or contextual embeddings may be written to NoSQL databases 236. When the extraction engine completes, normalized, query-optimized entries derived from the extracted language data, the elements can be written to NoSQL Database 338 according to parameters and logic defined for each functional application in the NoSQL (or cloud storage, or SQL) database 336. The visualization module (End User Data Visualization 326) may generate links that reference predefined views so that administrators or end users can view dashboards or reports directly tied to the extracted fields.

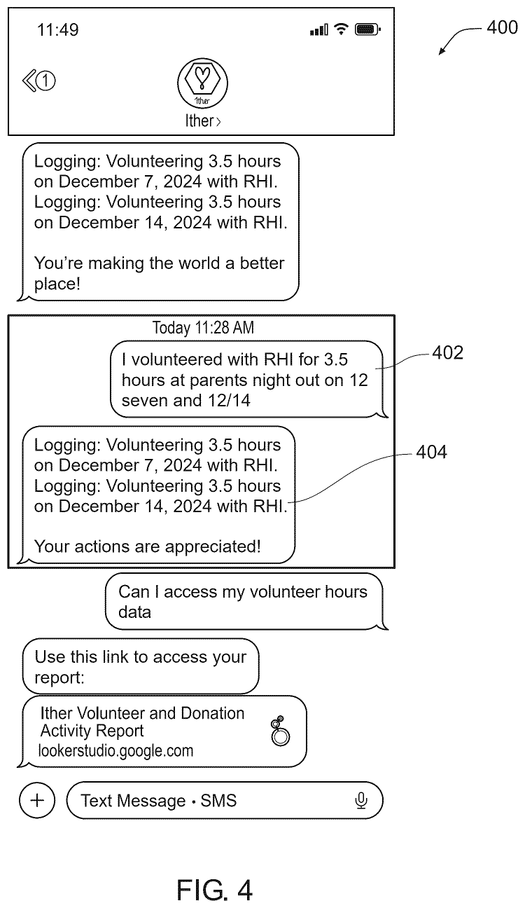

Turning to FIG. 4, an exemplary implementation of the system is shown. Specifically, FIG. 4 shows a use case in which a user 30 is a volunteer. In this example, the system 200 can allow the user 30 to log volunteer activities (e.g., a description of what was done and for how long) with the system via the text message interface 400. The figure shows the initial inbound message 402, and the confirmation message 404 to the user 30. To process the message, the system 300 extracts data from the incoming message 402 according to predefined configuration parameters. The data may be stored in databases 236 and a return message 404 may be sent to the user 30 to confirm the entry.

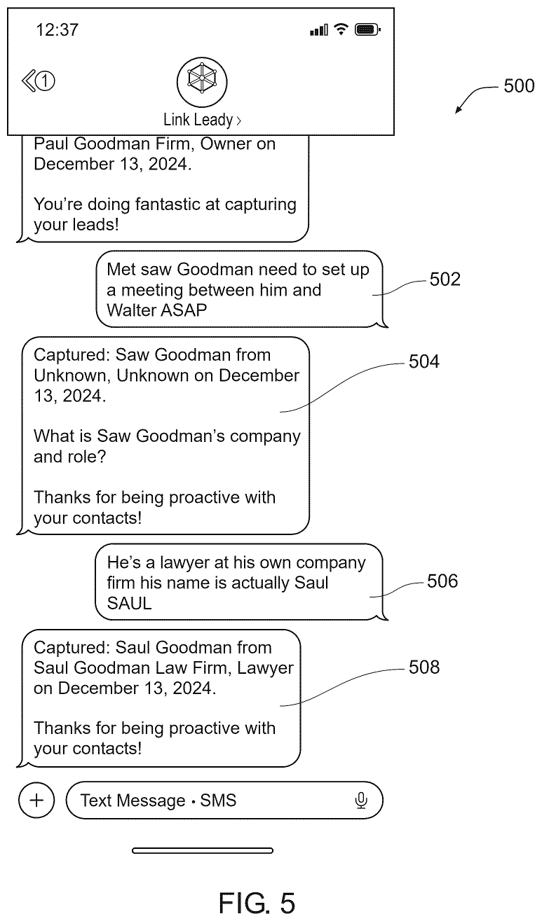

Turning to FIG. 5, another exemplary implementation of the system is shown. Specifically, FIG. 5 shows a use case in which a user 30 sends a message 502 regarding meeting with business contact. The incoming message 502 reads “Met saw Goodman need to set up a meeting between him and Walter ASAP.” The system responds to the user at 504 with “Captured: Saw Goodman from Unknown, Unknown on Dec. 13, 2024. What is Saw Goodman's company and role? Thanks for being proactive with your contacts!” In this example, the user 30 may have meant to type “Saul” instead of “Saw.” Therefore, to correct the error, the user 30 can reply at 506 with “He's a lawyer at his own company firm his name is actually Saul S.A.U.L.” The system updates the records and sends a confirmation message to the user 30 at text message 508.

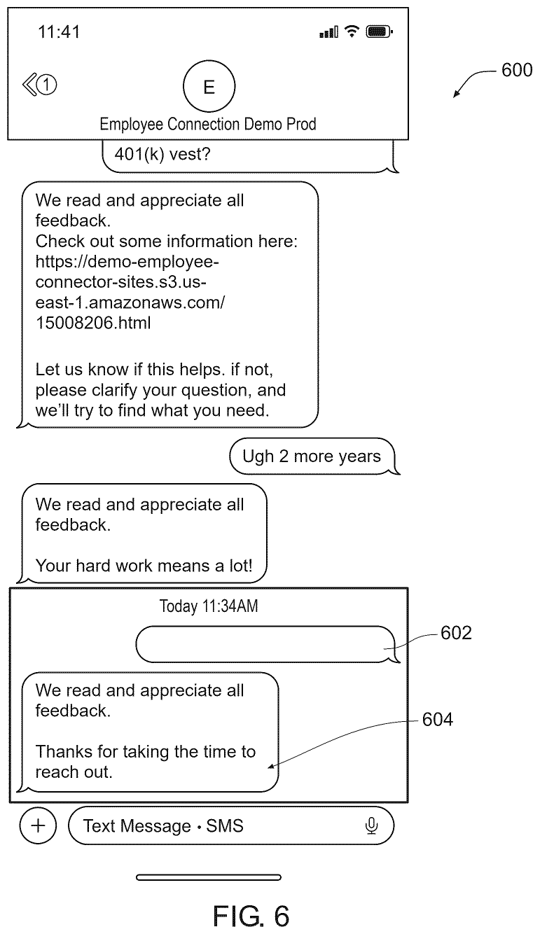

FIG. 6 illustrates an exemplary implementation in which the system 200 accepts feedback from the user 30 at 602. The system confirms the feedback at the return message 604.

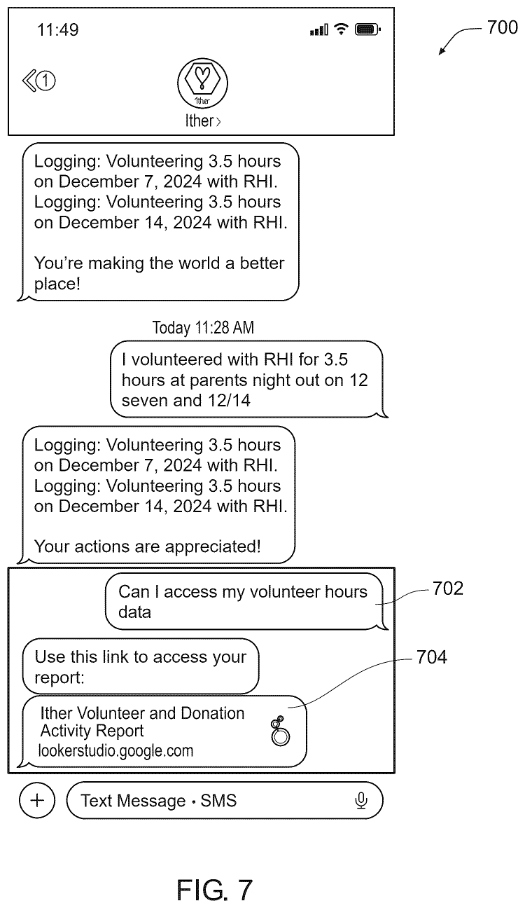

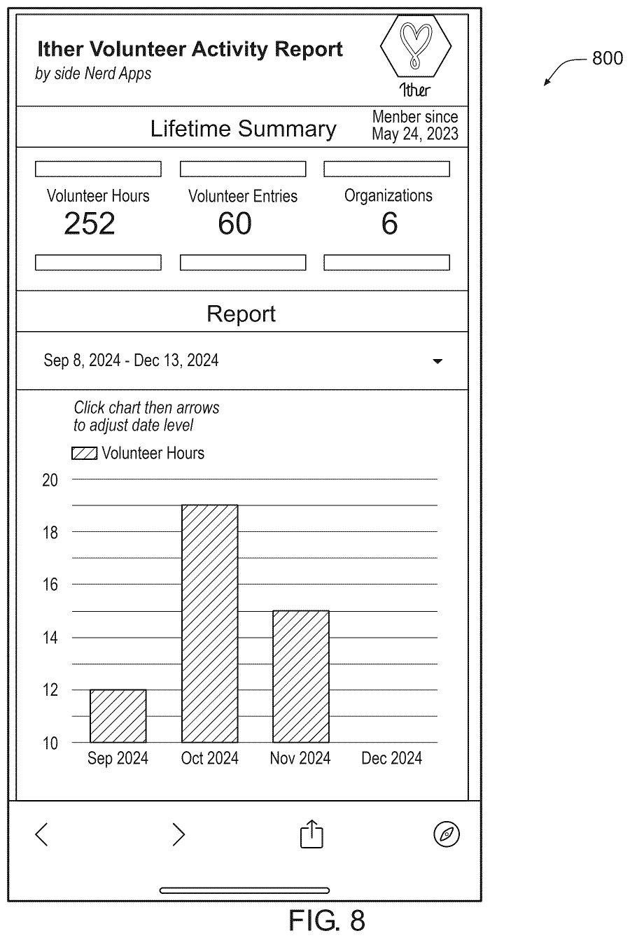

FIG. 7 illustrates an exemplary implementation in which the user 30 requests, at 702, to see a log of the user's volunteer hours. The system 200 responds at message 704 with a link to access the report. FIG. 8 illustrates an exemplary report 800 of the data requested in FIG. 7.

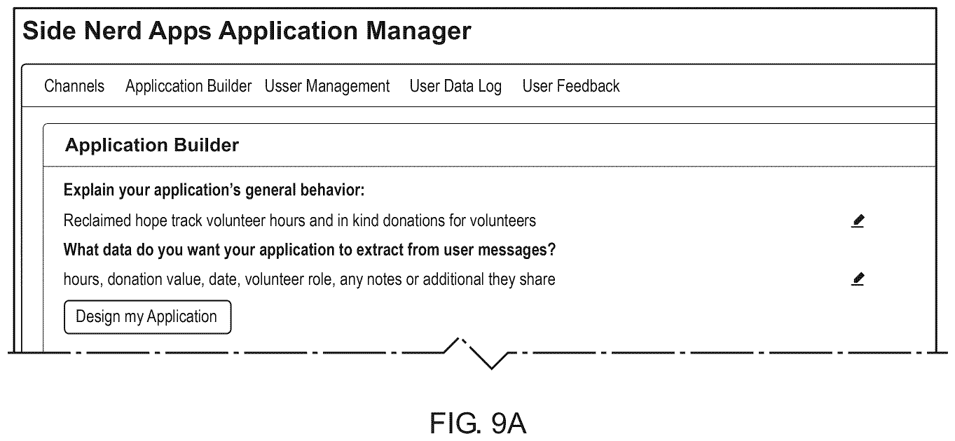

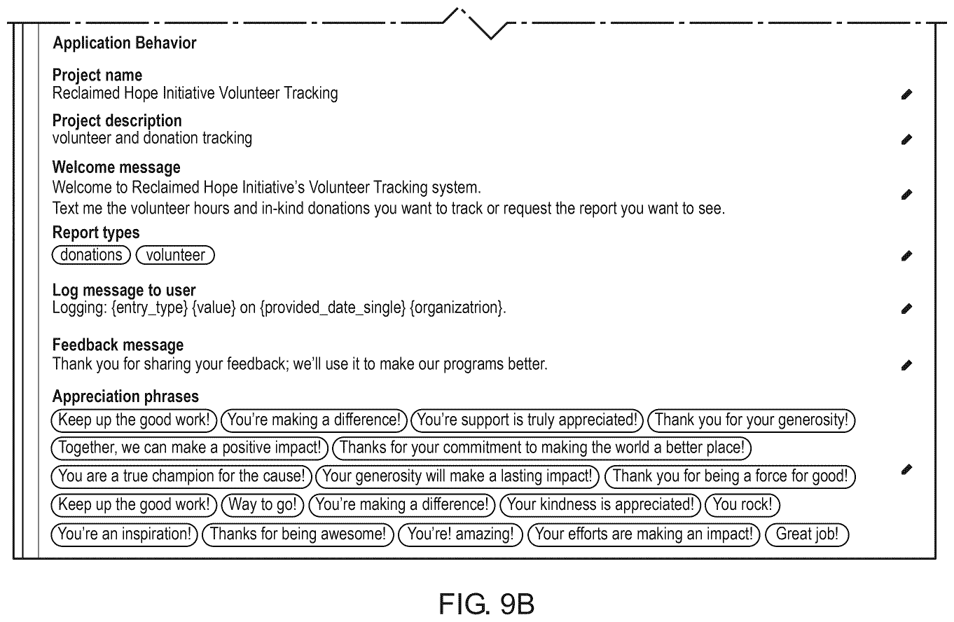

FIGS. 9-17 illustrate various administrative interfaces that may be used to access, configure, or access various aspects of the data tracking system 200. Specifically, FIG. 9 illustrates a no-code administrative interface where an admin 32 can describe desired application behaviors in natural language. The system converts these descriptions into application logic templates, allowing easy fine-tuning without coding.

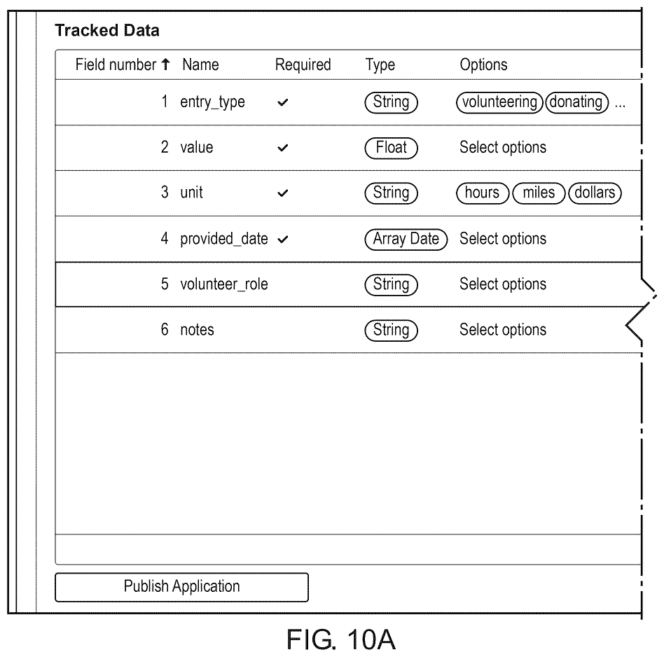

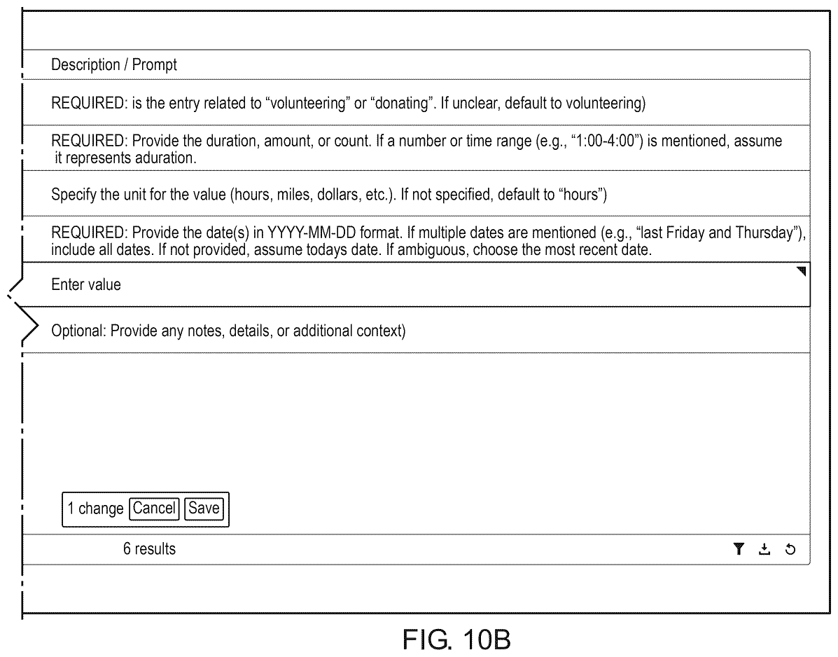

FIG. 10 illustrates a graphical illustration showing the form-based interface for defining required and optional data fields. It highlights how an admin 32 can specify field types, validation rules, and relationships to contextual datasets, ensuring consistent and structured data capture from user messages. This configuration may be referred to as configuration of language tracking parameters.

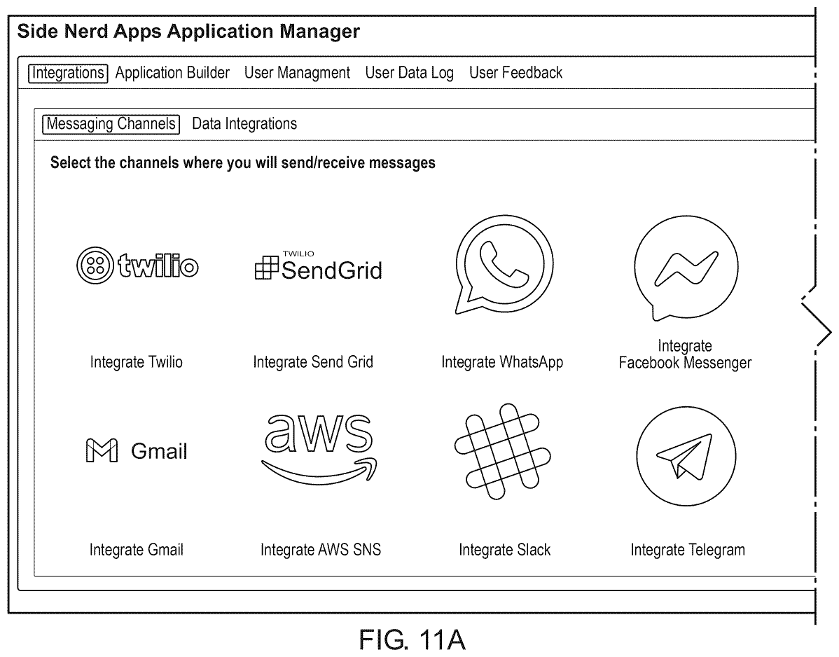

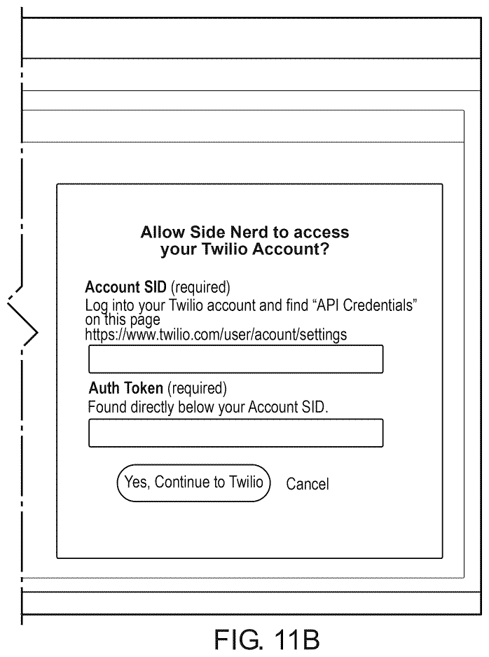

FIG. 11 illustrates a diagram showing how the admin 32 can configure integrations with various messaging channels (e.g., SMS, email, chat platforms) or assign a default text-able phone number. This figure may also demonstrate channel-agnostic configuration without altering core application logic.

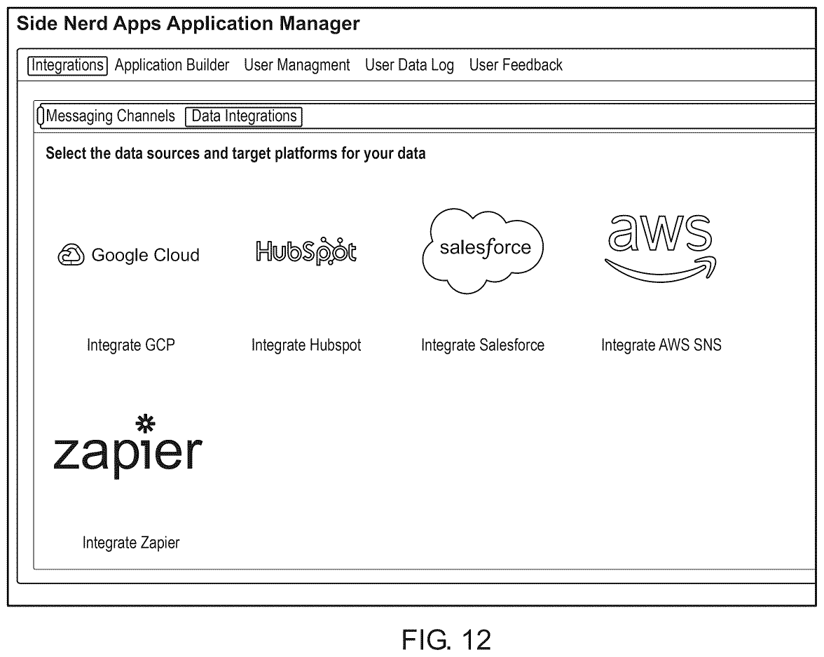

FIG. 12 illustrates a depiction of how admins 32 may integrate to the system 200 with external databases, CRMs, or SaaS platforms.

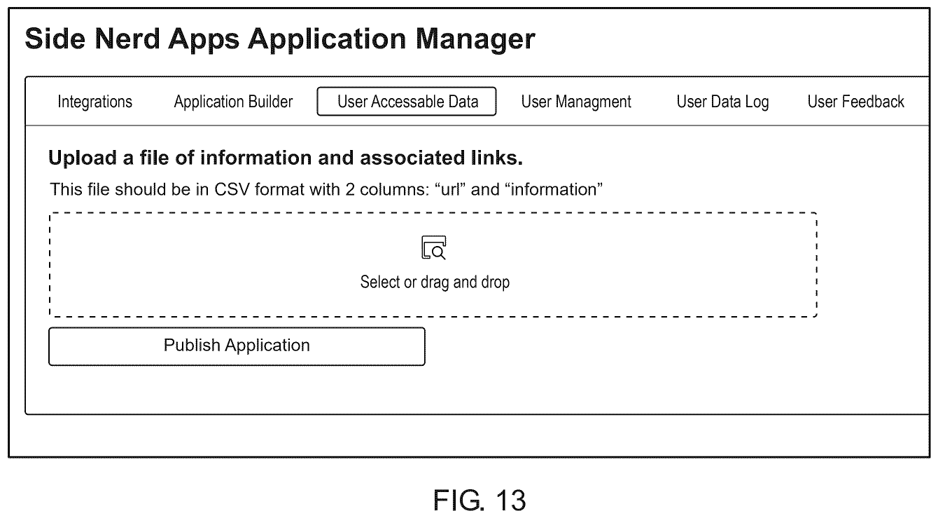

FIG. 13 illustrates how an admin 32 can upload CSV files or other data sources to enrich the system's contextual dataset. It also shows how the system 200 may generate embeddings and store them for later semantic retrieval, enabling context-aware responses to end users.

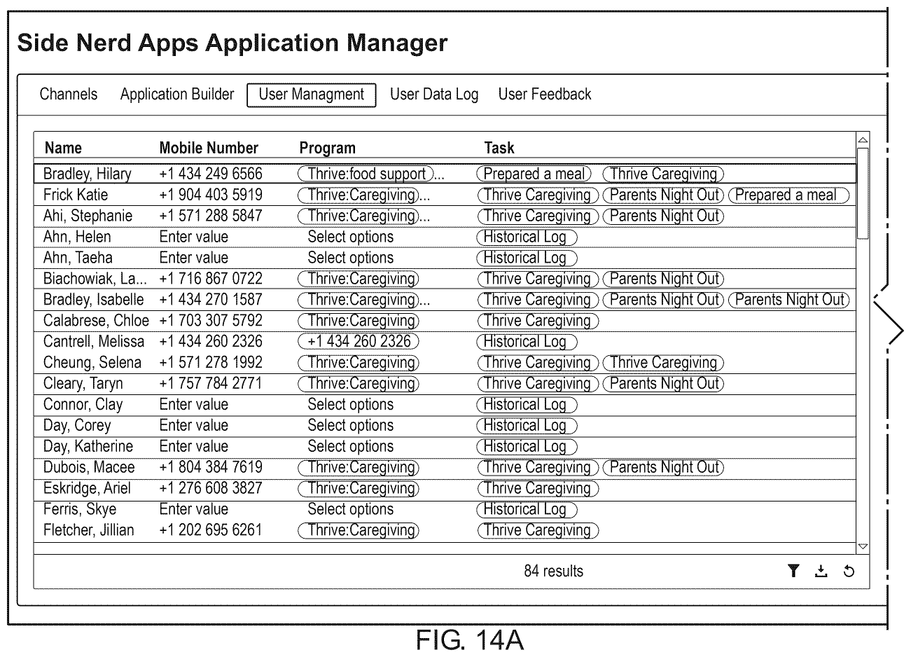

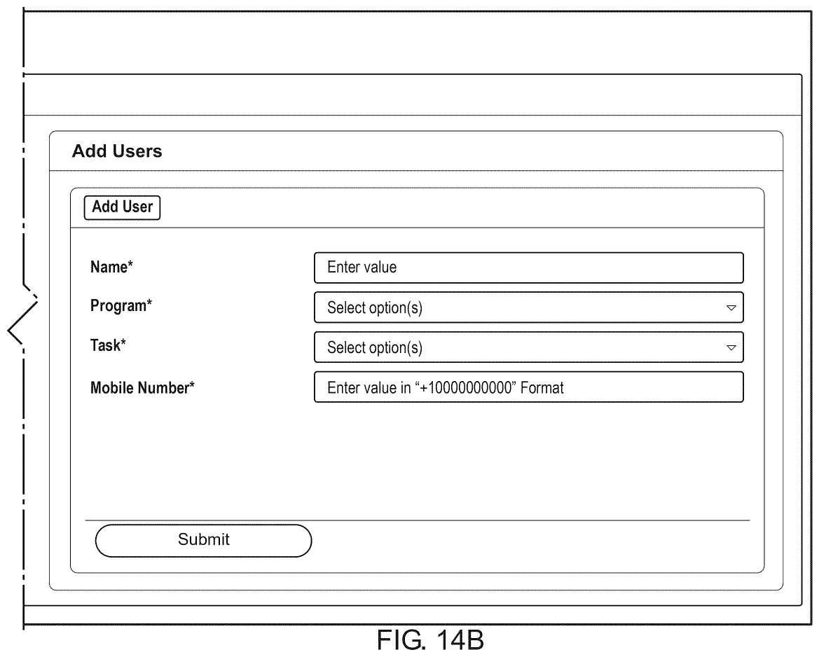

FIG. 14 illustrates a platform in which the admin 32 can define user groups, assign application logic to these groups, and grant or restrict access. This figure may also illustrate the system's capacity to customize behavior and data extraction based on user metadata (such as Mobile Number).

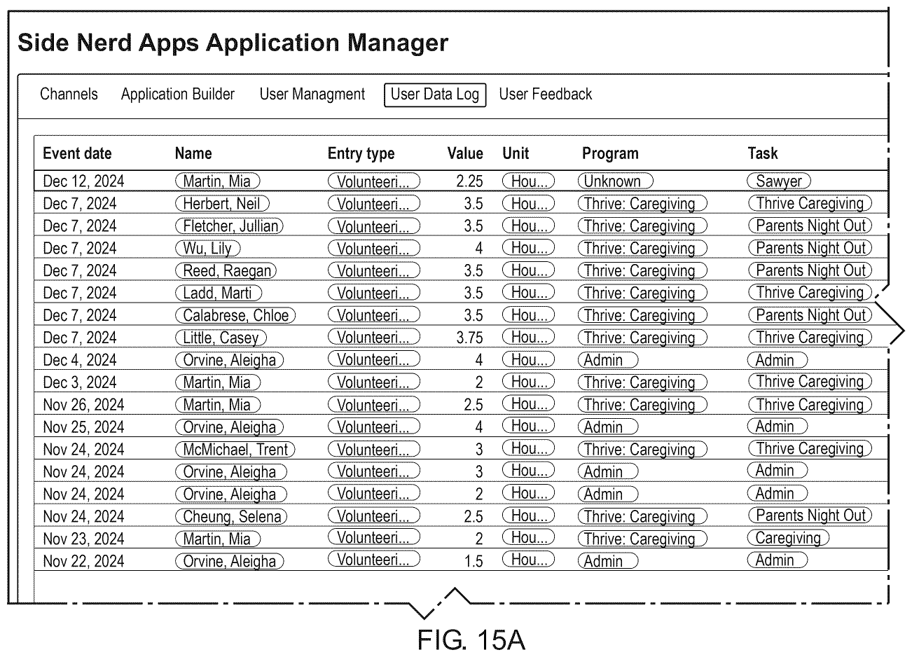

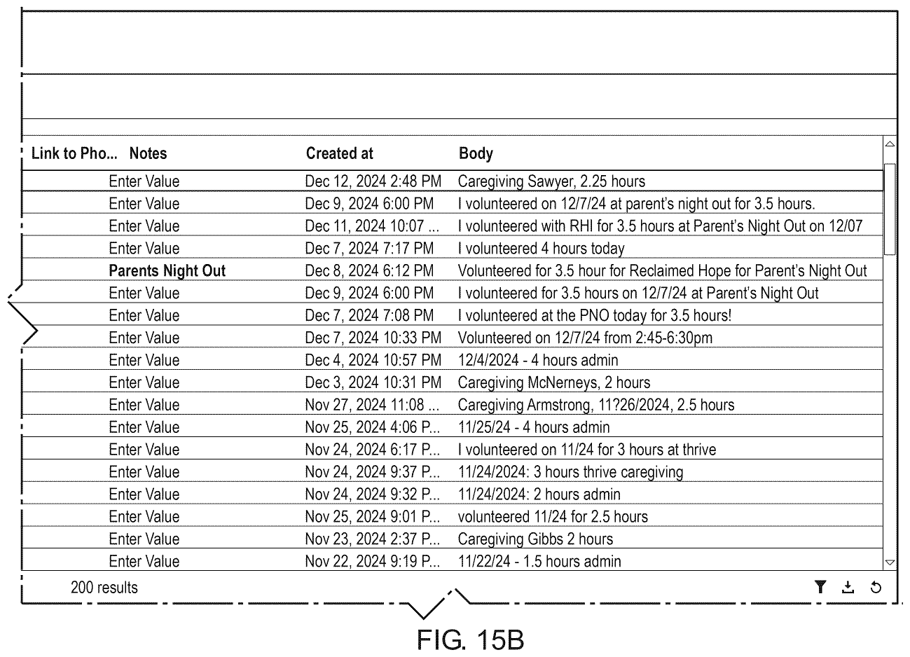

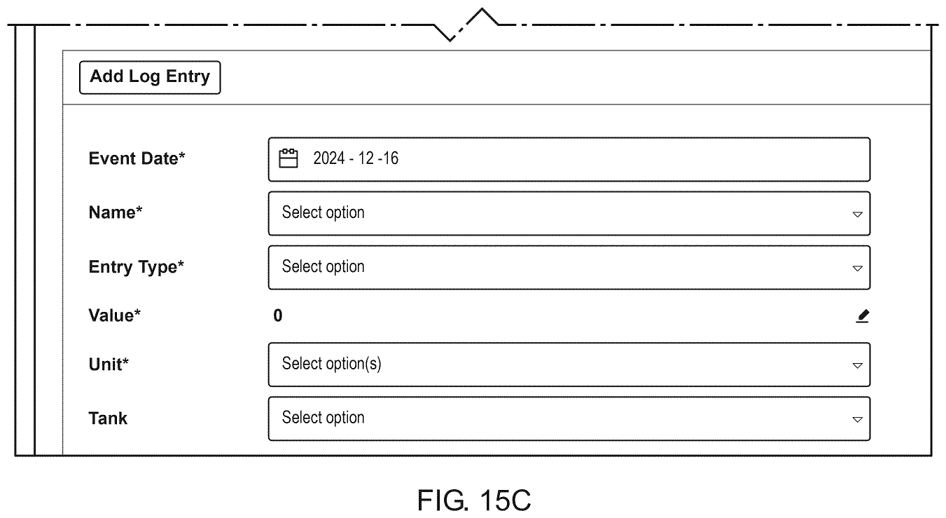

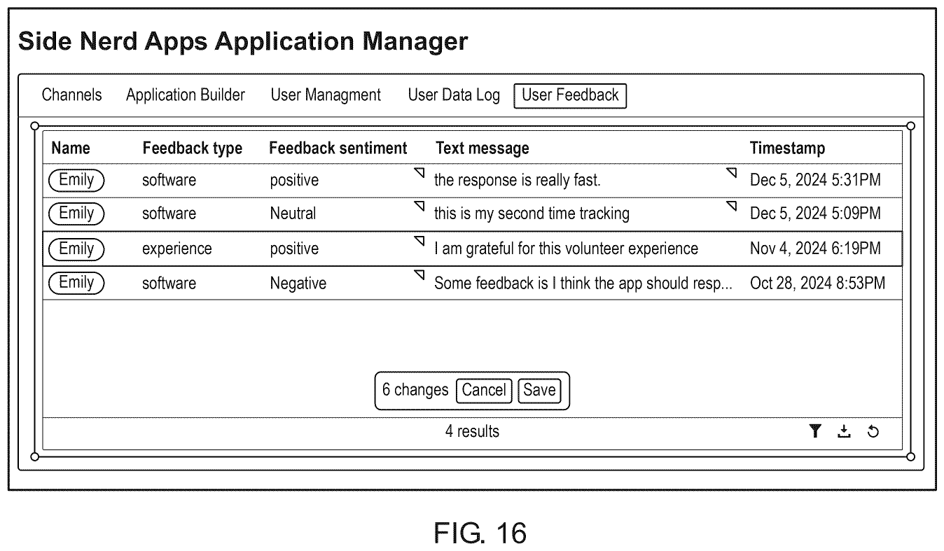

FIGS. 15-16 illustrates visual representations of how the admin 32 can view, edit, or manually add log entries, as well as review end-user feedback. The figure highlights interactive tables and forms that allow direct manipulation of stored data for corrections or analysis.

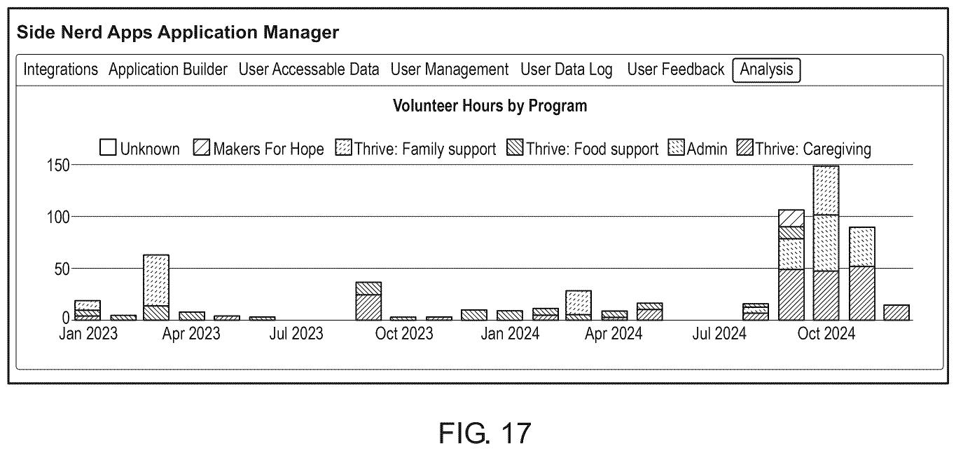

FIG. 17 illustrates how admins can review aggregated metrics, and present data insights to both internal stakeholders and end users.

It should be noted that although certain tasks are described with respect to users 30, 32, and 34, either or any of the users 30, 32, and 34 may access or benefit from any or all of the actions disclosed herein.

One of ordinary skill in the art can appreciate that the various embodiments of the system or applications described herein can be implemented in connection with any computing device, client device, or server device, which can be deployed as part of a computer network or in a distributed computing environment such as the cloud. The various embodiments described herein can be implemented in substantially any computer system or computing environment having any number of memory or storage units, any number of processing units, and any number of applications and processes occurring across any number of storage units and processing units. This includes, but is not limited to, cloud environments with physical computing devices (e.g., servers) aggregating computing resources (i.e., memory, persistent storage, processor cycles, network bandwidth, etc.) which are distributed among a plurality of computable objects. The physical computing devices can be aggregated and exposed according to various levels of abstraction for use by application or service providers, to provide computing services or functionality to client computing devices. The client computing devices or user devices can access the computing services or functionality via application program interfaces (APIs), web browsers, or other standalone or networked applications. Accordingly, aspects of the applications, modules, or interfaces can be implemented based on such a cloud environment. For example, the applications can reside in a cloud computing environment such that the computer-executable instructions implementing the functionality thereof are executed with the aggregated computing resources provided by the plurality of physical computing devices. The cloud computing environment provides one or more methods of access to the subject innovation, which are utilized by the applications.

Although certain embodiments have been shown and described, it is understood that equivalents and modifications falling within the scope of the appended claims will occur to others who are skilled in the art upon the reading and understanding of this specification.

What is claimed is:

1. A system for tracking text or media-based language data, comprising:
an administrative interface for configuring one or more language tracking parameters, wherein the one or more language tracking parameters comprise a data extraction schema that defines one or more language data elements that are to be extracted from incoming language data received from a user device, and a user interaction schema that governs at least one interaction with user device;
a data routing interface configured to receive the incoming language data from the user device and to route the incoming language data to one or more modules of the system;
a data processing module configured to analyze and extract language data elements from the incoming language data, wherein the language data elements are extracted from the incoming language data according to the data extraction schema;
at least one data storage module comprising at least one database configured to store at least a portion of the incoming language data and the language data elements that are extracted from the incoming language data; and
an outgoing data interface configured to send, according to the user interaction schema, at least one prompt to the user.

2. The system of claim 1, wherein the at least one data storage module comprises at least one NoSQL database.

3. The system of claim 2, wherein the at least one NoSQL database is configured to store one or more of:
the incoming language data;
configuration data;
contextual embeddings;
or raw messages, and
is further configured to store structured, queryable data entries derived from the language data elements extracted from the incoming language data.

4. The system of claim 1, wherein the user interaction schema defines one or more of text-based prompts communicated to the user, hints or questions communicated to the user, validation rules and disambiguation thresholds, follow-up question templates, response templates, branching and escalation rules, or channel-specific formatting schemes.

5. The system of claim 4, wherein the administrative interface is a no-code, form-based administrative interface configured to enable an administrator to define, without writing code, the one or more language tracking parameters.

6. The system of claim 1, wherein the incoming language data comprises one or more of the following:
SMS text messages;
audio messages;
picture messages; or
video messages, and
wherein the incoming language data relates to at least one social, professional, educational, recreational, or service-oriented interactions.

7. The system of claim 1, wherein the data routing interface is configured to select and apply an application configuration to the incoming language data, based at least partly on message metadata, to allow multiple modules, applications or logic sets to be managed within the system.

8. The system of claim 7, wherein the data routing interface comprises at least one of an incoming API, outgoing API, or API Gateway.

9. The system of claim 1, further comprising a visualization module configured to generate at least one visualization link which references at least one database of the storage module to enable one or more of the user or the administrator to view at least one dashboard or report based on the language data elements extracted from the incoming language data, without requiring custom development or external integrations.

10. A method for tracking text-based language data, comprising:
configuring, via an administrative interface, one or more language tracking parameters, wherein the one or more language tracking parameters comprise a data extraction schema that defines one or more language data elements that are to be extracted from incoming language data received from a user device, and a user interaction schema that governs at least one interaction with user device, the incoming language data is related to a language tracking scenario;
receiving, via a data routing interface, incoming language data associated with the language tracking scenario, and routing the incoming language data to one or more modules of a language processing system;
extracting, via a data processing module, the one or more language data elements from the incoming language data according to the data extraction schema;
storing, in one or more databases, at least a portion of the incoming language data and the language data elements extracted from the incoming language data; and
transmitting, based at least in part on the user interaction schema, one or more user prompts to the user device related to the language tracking scenario.

11. The method of claim 10, wherein the one or more databases comprise at least one NoSQL database.

12. The method of claim 11, wherein the at least one NoSQL database is configured to store one or more of:
the incoming language data;
configuration data;
contextual embeddings;
or raw messages, and
is further configured to store structured, queryable data entries derived from the language data elements extracted from the incoming language data.

13. The method of claim 10, wherein the incoming language data comprises one or more of the following:
SMS text messages;
audio messages;
picture messages; or
video messages, and
wherein the incoming language data relates to at least one social, professional, educational, recreational, or service-oriented interactions.

14. The method of claim 10, wherein the incoming language data comprises SMS text messages that comprise data related to a volunteer activity and the one or more user prompts are questions to the user regarding the volunteer activity.

15. The method of claim 10, wherein the user interaction schema defines one or more of text-based prompts communicated to the user, hints or questions communicated to the user, validation rules and disambiguation thresholds, follow-up question templates, response templates, branching and escalation rules, or channel-specific formatting schemes.

16. The method of claim 15, wherein the administrative interface is a no-code, form-based administrative interface configured to enable an administrator to define, without writing code, the one or more language tracking parameters.

17. The method of claim 10, wherein the data routing interface is configured to select and apply an application configuration to the incoming language data, based at least partly on message metadata, to allow multiple modules, applications or logic sets to be managed within the system.

18. The method of claim 10, further comprising:
generating, via a visualization module, at least one visualization link referencing the one or more databases to enable one or more of the user or administrator to access at least one dashboard or report based on structured data extracted from the incoming language data.

19. One or more non-transitory computer-readable storage media, having computer-executable instructions embodied thereon, wherein when executed by at least one processor, the computer-executable instructions cause the processor to:
configure, via an administrative interface, one or more language tracking parameters, wherein the one or more language tracking parameters comprise a data extraction schema that defines one or more language data elements that are to be extracted from incoming language data received from a user device, and a user interaction schema that governs at least one interaction with user device, the incoming language data is related to a language tracking scenario;
receive, via a data routing interface, incoming language data associated with the language tracking scenario, and routing the incoming language data to one or more modules of a language processing system;
extract, via a data processing module, the one or more language data elements from the incoming language data according to the data extraction schema;
store, in one or more databases, at least a portion of the incoming language data and the language data elements extracted from the incoming language data; and
transmit, based at least in part on the user interaction schema, one or more user prompts to the user device related to the language tracking scenario.

20. The non-transitory computer-readable storage media of claim 19, further configured to:
generate, with a visualization module, at least one visualization link referencing the one or more database.
